(19) United States
(12) Patent Application Publication
(10) Pub. No.: US 2023/0341078 A1
(43) Pub. Date: Oct. 26, 2023

(54) THERMAL INSULATION BLANKET FOR UNDERSEA LINES

(71) Applicant: Petróleo Brasileiro S.A. - Petrobras, Rio de Janeiro (BR)

(72) Inventors: Gustavo Geraldo Pappen, Vitória (BR); Henri Fiorenza De Lima, Vila Velha (BR)

(21) Appl. No.: 18/043,822

(22) PCT Filed: Sep. 9, 2021
(86) PCT No.: PCT/BR2021/050388

§ 371 Date: Mar. 2, 2023

(30) Foreign Application Priority Data
Sep. 11, 2020 (BR) 102020018635-3

(51) Int. Cl. F16L 59/14; F16L 59/02

(52) U.S. Cl. CPC F16L 59/14; F16L 59/026

(57) ABSTRACT

The present invention addresses to a blanket for thermal insulation of submarine pipelines to favor the maintenance of temperatures above the desired minimum in the respective designs, since the fluids internally transported tend to lose heat to the environment. It solves problems that occur with the formation of paraffins or scales, the increase in oil viscosity and the formation of hydrate, among others. The invention must be launched at greater depths (where the external temperature is lower) and close to the origin of the fluids, where these will have the maximum temperature and, as this variation will be maximum, the thermal exchange potential will be more intense. The blanket then keeps the water heated by the pipeline confined to the surroundings thereof, acting as additional insulation. In addition, it is installed longitudinally on the pipelines in which it operates, by being unwound (to facilitate installation).

### FIELD OF THE INVENTION

The present invention addresses to a blanket for thermal insulation of submarine pipelines, used in the field of lifting and oil flow technologies, mainly in long tie-backs where the temperature drop is a critical item to guarantee the flow of the produced fluids, aiming at favoring the maintenance of temperatures above the desired minimum in the respective designs.

### DESCRIPTION OF THE STATE OF THE ART

For pipelines of long lengths and in deep water, insulation is very important, since there is more time for the fluids internally transported to exchange heat with the environment, favoring the reaching of temperatures below the minimum that is comfortable for the respective designs. The thermal insulation of pipelines is a critical item for maintaining the temperature of transported fluids. Such a concern is mainly due to problems with the potential to occur, such as paraffin formation, increased oil viscosity and hydrate formation, among others.

Typical configurations are, whether for rigid or flexible pipelines, the use of thermal insulation layers. These raise the cost of pipelines significantly. When conventional insulation (layers of syntactic polypropylene) does not meet the needs, the use of Pipe-in-pipe technology can be used, where one pipeline inside the other has the annular space filled with some type of more efficient thermal insulator, and it is protected, as it does not have mechanical resistance (typical material: Aerogel). This solution is much more complex and expensive to build and install. An alternative that has been used in some designs is the burying of the pipeline, which provides insulation and also reduces heat exchange by convection, where the cold water, in contact with the pipeline that conducts the hot fluid, heats up and moves to above, allowing the exchange to take place more intensely. Such a burial process may not dispense with the use of additional insulation and involves other variables: specialized equipment for such burial, operated remotely; high costs; risks of damage to the pipeline; and risk of undercurrents “digging up” the pipeline.

The present invention must be launched in sections where the thermal exchange tends to be more pronounced, typically at greater depths (where the external temperature is lower) and close to the origin of the fluids (where they will have the maximum temperature and, as the variation of this will be maximum, the exchange will be more intense). The length must be sufficient so that the temperatures (assessed by simulation) can remain above the admissible limits. The blanket will then keep the water heated by the pipeline confined to its surroundings, acting as an additional insulation.

Document WO1997033122A1 addresses to a piping insulation blanket and an insulating cell for a piping insulation blanket. The blanket comprises at least one insulating cell, the or each insulating cell comprising a protective layer and an insulating layer. Advantageously, the insulating layer is completely surrounded by the protective layer. The protective layer is suitably concrete, preferably high-strength concrete. The protective layer provides the rigidity to hold the blanket together, i.e., it provides reinforcement for the blanket. In addition, the protective layer can protect the insulating layer from prevailing seabed conditions, such as high pressure, and can protect the insulating layer from seawater ingress. The insulating layer is a material with a low thermal conductivity, which is preferably in the range of 0.015 to 0.04 W/m·K, more preferably 0.022 to 0.039 W/m·K. An example of a suitable insulating material is polystyrene foam. The thickness of the concrete layer around the insulating layer is desirable in the range from 20 to 40 mm, and can be in the range from 20 to 30 mm. Document WO1997033122A1 does not seem to demonstrate advantages in terms of installability, since its concrete cells do not allow for a curvature that facilitates launching from coils. It also seems to act only in the transmission of heat by conduction, which can be obtained by the intrinsic or complementary insulation that may be present in the pipeline itself. The document also suggests an alternative configuration that works along the entire circumference of the pipeline. The necessary adjustment to the pipeline to be protected suggests that its application is limited to shallow waters, given the precision of the launch. The cells would not support pressures of 190 to 200 bar (19 to 20 MPa), unlike the present invention, since the cells would be an inverse pressure vessel (very high pressures from outside to inside). Another problem is that, for large distances, it would be necessary to manufacture billions of concrete cells (they need a curing time to avoid premature dehydration), in addition to the fact that the insulating material could contaminate the local fauna in case of failure in the structure. Therefore, the document differs from the present invention, which has advantages such as easy manufacturing, greater strength and flexibility, ease of being wound in large quantities, in addition to not being in contact with the pipeline.

Document PI0402391-9A addresses to a thermal insulating blanket system (Capa) for pipelines, risers and subsea equipment, easy and quick to install during their launching and recovery on the seabed. This blanket is built in a format and material that provides the same flexibility enough to be wound on spools or accommodated in boxes or any other means that facilitates its storage, transport and handling during the installation or recovery of subsea pipelines and equipment. This proposal is a field coating, ideal for repairs or applications in joints, but unfeasible for large extensions, in view of the very high cost of the launching vessel and the time required for its application in the pipeline. Unlike the present invention, in the case of pipelines resting on the seabed, the document discloses that the entire piping is wrapped with the blanket and, despite mentioning that in certain situations they may use elements that have empty spaces (hollows) to function as thermal insulators, the document does not mention using water itself as a thermal insulator.

Document CA2524830C addresses to a lightweight and compact insulation system that is also capable of withstanding a high level of compressive load. The system utilizes spacers to provide structural support and uses controlled buckling of a thin protective outer carrier tube supported by spacers to form strong catenary surfaces to protect the insulation material underneath. The spacers can comprise an aerogel, or an aerogel can provide insulation separate from the spacer still contained in the thin outer layer. The document, as well as the present invention, presents a means to reduce heat loss from the piping to the environment, using thermal insulation, but it is an alternative configuration of pipe-in-pipe, which differs from the conventional one in the configuration of the spacer (in this case, helical). It is a very expensive technology for which an alternative is precisely being sought. This is used when the other strategies do not manage to maintain the temperature of the transported fluids required in a given situation/design. It also differs from the present invention in that it does not consider the blanket detached from the piping, which would leave empty spaces for the water to be confined and heated by the piping, being used as an additional thermal insulator.

The present invention addresses to a thermal insulation of submarine pipelines to favor the maintenance of temperatures above the desired minimum in the respective designs, differently from what is disclosed by the documents of the state of the art.

### BRIEF DESCRIPTION OF THE INVENTION

The present invention addresses to a blanket for thermal insulation of submarine pipelines to favor the maintenance of temperatures above the desired minimum in the respective designs, since the fluids internally transported tend to lose heat to the environment. It solves issues regarding potential paraffin formation, increased oil viscosity and hydrate formation, among others.

The invention is launched at greater depths (where the external temperature is lower) and close to the origin of the fluids (where these will have the maximum temperature and, as the variation of this will be maximum, the exchange will be more intense). The blanket, when installed, will keep the water heated by the pipeline confined to its surroundings, acting as an additional insulation. In addition, it will be arranged longitudinally on the pipelines in which it will act, being unwound (to facilitate installation).

### Objectives of the Invention

The present invention aims at favoring the maintenance of temperatures above the desired minimum in the respective designs.

The present invention aims at reducing the CAPEX (cost of acquiring capital goods) of designs, since the technology (material and installation service) tends to be cheaper.

Another objective of the present invention is to protect the region under the pipeline from the occurrence of silting and formation of free spans, which potentiate fatigue problems in the pipelines (mainly in the rigid ones), avoiding the need for pads.

The present invention also aims at increasing productivity, since, by keeping the temperature higher, production levels tend to increase and the risks of production interruption and/or the need for pig passages tend to decrease.

In addition to the objectives, the blanket has the advantage of being installed in pipelines that are in operation, without the need for removal or production stoppage.

### BRIEF DESCRIPTION OF THE DRAWINGS

The present invention will be described in more detail below, with reference to the attached figures which, in a schematic way and not limiting the inventive scope, represent examples of the same. In the drawings, there are:

FIG. 1 illustrates the typical configurations (isolated and buried pipeline) and the proposed configuration of the blanket;

FIG. 2 illustrates the proposed invention in perspective view.

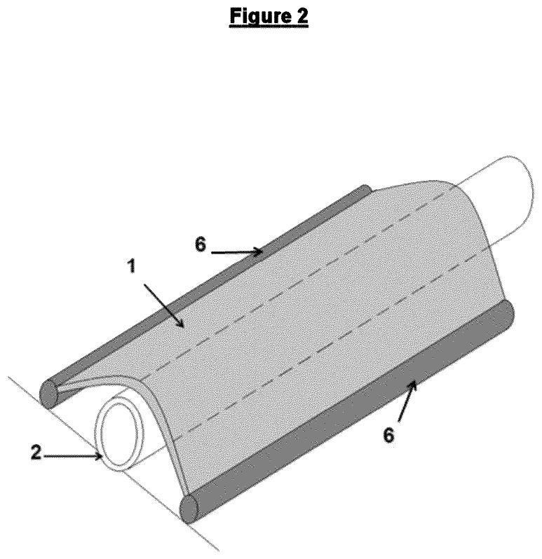

### DETAILED DESCRIPTION OF THE INVENTION

Preliminarily, it is emphasized that the description that follows will start from preferred embodiments of the invention. As will be apparent to any technician skilled on the subject, however, the invention is not limited to these particular embodiments, but rather to the scope defined in the claims.

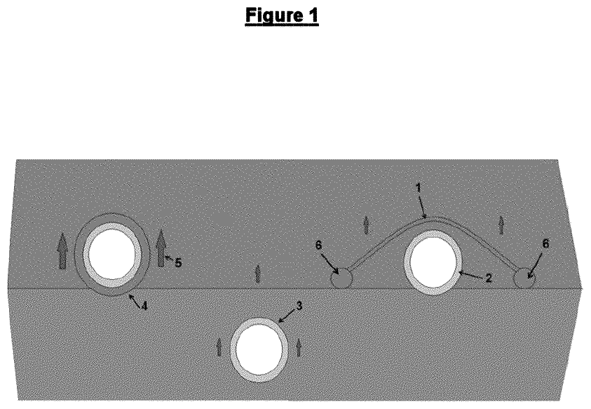

The present invention addresses to a blanket (1) for thermal insulation of submarine pipelines (2) to favor the maintenance of temperatures above the desired minimum in the respective designs, since the fluids internally transported tend to lose heat to the environment. In FIG. 1, it is possible to see the typical configurations, isolated (4) and buried (3) pipeline, the blanket (1) of the present invention isolating the pipeline (2) and the representation of the convection (5) in the site, smaller in the situations of buried pipeline and in the use of the blanket, when compared to the isolated pipeline. The blanket (1) is installed longitudinally over the pipeline (2) in which it will act, being unwound (to facilitate the installation). It has a width compatible with the diameter of the pipeline (2) and the sizing must be done according to the specific design. The blanket (1) has built-in weights (6) on both sides (which may be reservoirs of sand, cement or other high-density and low-cost material) that serve to prevent the blanket (1) from being removed by undercurrents or the water heated and confined thereunder. The blanket (1) has tensile strength to allow its launching, supporting its own weight for the lengths to be adopted for each section. It also has ways of attachment to the launch and recovery tools, containing means of attachment between sections, to facilitate installation and recovery. The blanket (1) keeps the water heated by the pipeline (2) confined in its surroundings, acting as an additional insulation. The blankets (1) are watertight, in order to hinder the convection formed by the difference in temperature of the water, heated by the pipeline itself (2). It is desirable, but not necessary, that the blanket (1) has reinforcements or spacers that keep the same “assembled” in order to prevent it from being in contact with the pipeline (2), reducing the efficiency of its use. Such reinforcements must be sufficiently flexible so that the blanket (1) can be loaded in coils, facilitating its installation.

Finally, the material used in the thermal blanket is the same used by several other techniques, which may be the same as described in application PI 0402391-9A, or provided that they have low thermal conductivity, preferably equivalent to polystyrene or polyurethane and have low mechanical stiffness and high zone of elasticity (high creep point/limit). The combination of material chosen is directly proportional to the thickness of the blanket. Accordingly, the overall heat transfer coefficient has low values to ensure thermal insulation.

1. A BLANKET FOR THERMAL INSULATION OF SUBMARINE PIPELINES, having thermo-insulating materials and high elasticity, characterized in that it has a width compatible with the diameter of the pipeline (2), being unwound longitudinally over the pipeline (2), contains side weights (6), being completely watertight, and optionally has flexible reinforcements or spacers.

2. THE BLANKET FOR THERMAL INSULATION OF SUBMARINE PIPELINES according to claim 1, characterized in that the lateral weights (6) prevent the blanket (1) from being removed by the forces of undercurrents and convection (5) of the water heated under the same.

3. THE BLANKET FOR THERMAL INSULATION OF SUBMARINE PIPELINES according to claim 1, characterized in that the water heated by the pipeline itself (2) is confined in the vicinity of the pipeline (2) and acts as an additional insulator.

4. A BLANKET FOR THERMAL INSULATION OF SUBMARINE PIPELINES, characterized in that it has tensile strength to allow its launching and support its own weight for the adopted lengths of each section.

5. A BLANKET FOR THERMAL INSULATION OF SUBMARINE PIPELINES, characterized in that it has attachment means between sections.

6. THE BLANKET FOR THERMAL INSULATION OF SUBMARINE PIPELINES according to claim 1, characterized in that flexible reinforcements or spacers keep the blanket (1) assembled and prevent contact between the blanket (1) and the pipeline (2).
